(19) United States
(12) Patent Application Publication
(10) Pub. No.: US 2026/0167098 A1
(43) Pub. Date: Jun. 18, 2026

(54) IN-VEHICLE DISPLAY DEVICE, DISPLAY CONTROL DEVICE, AND DISPLAY CONTROL METHOD

(71) Applicant: Sony Group Corporation, Tokyo (JP)

(72) Inventor: Tomoki HAMAJIMA, Tokyo (JP)

(73) Assignee: Sony Group Corporation, Tokyo (JP)

(21) Appl. No.: 18/703,898

(22) PCT Filed: Nov. 1, 2022
(86) PCT No.: PCT/JP2022/040851

§ 371 Date: Mar. 10, 2026

(30) Foreign Application Priority Data
Nov. 15, 2021 (JP) 2021-185587

(51) Int. Cl. B60Q 1/50; G06F 3/14

(52) U.S. Cl. CPC B60Q 1/5037; B60Q 1/543; G06F 3/1423

(57) ABSTRACT

The present technology relates to an in-vehicle display device, a display control device, and a display control method capable of easily presenting a direction in which a vehicle travels to a pedestrian or the like around the vehicle. Control is performed such that a first image indicating a traveling direction of the vehicle is displayed on a front surface of the vehicle on the basis of a state of the vehicle or position information of the vehicle, and control is performed such that a second image indicating the traveling direction of the vehicle and different from the first image is displayed on a rear surface of the vehicle.

### TECHNICAL FIELD

The present technology relates to an in-vehicle display device, a display control device, and a display control method, and particularly relates to an in-vehicle display device, a display control device, and a display control method capable of easily presenting a direction in which a vehicle travels to a pedestrian or the like around the vehicle, in particular.

### BACKGROUND ART

Patent Literature 1 discloses that markers indicating traveling directions are mounted on front, rear, left, and right sides of a vehicle.

### CITATION LIST

### Patent Document

Patent Document 1: WO 2020/195607 A

### SUMMARY OF THE INVENTION

### Problems to be Solved by the Invention

In recent years, interest in automated driving systems has increased. In particular, there is an increasing demand for an automated vehicle that travels at a low speed in the same environment as a pedestrian or a bicycle, in means of transportation for elderly people, small-scale distribution, and the like. However, in a case where the automated vehicle travels in the same environment as the pedestrian, there are the following problems: it is difficult for the pedestrian to predict in which direction the automated vehicle will travel; and some pedestrians are scared about the automated vehicle. For example, Patent Literature 1 discloses that markers indicating traveling directions are mounted on the front, rear, left, and right of a vehicle. However, indicating a direction in which the vehicle turns is not described at all, and arrow indication different in the front and the rear of the vehicle is not also described. For this reason, it has been difficult for pedestrians around the vehicle to intuitively recognize the traveling direction of the vehicle.

The present technology has been made in view of such a situation, and makes it possible to present a direction in which a vehicle travels to a pedestrian or the like around the vehicle in an easy-to-understand manner.

### Solutions to Problems

An in-vehicle display device according to a first aspect of the present technology is an in-vehicle display device including: a first display unit mounted on a front surface of a vehicle; a second display unit mounted on a rear surface of the vehicle; and a display control unit that performs control to display a first image on the first display unit, the first image indicating a traveling direction of the vehicle, and performs control to display, a second image on the second display unit, the second image indicating the traveling direction of the vehicle and different from the first image, on the basis of a state of the vehicle or position information of the vehicle.

In the in-vehicle display device according to the first aspect of the present technology, on the basis of a state of the vehicle or position information of the vehicle, control is performed such that the first image indicating the traveling direction of the vehicle is displayed on the front surface of the vehicle, and control is performed such that a second image indicating the traveling direction of the vehicle and different from the first image is displayed on a rear surface of the vehicle.

A display control device according to a second aspect of the present technology is a display control device including a display control unit that controls display of a first image on a front surface of the vehicle, the first image indicating a traveling direction of a vehicle and controls display of a second image on a rear surface of the vehicle, the second image indicating the traveling direction of the vehicle and different from the first image, on the basis of a state of the vehicle or position information of the vehicle.

A display control method according to the second aspect of the present technology is a display control method of a display control device including a display control unit, the display control method including causing the display control unit to control display of a first image on a front surface of the vehicle, the first image indicating a traveling direction of a vehicle, and controls display of a second image on a rear surface of the vehicle, the second image indicating the traveling direction of the vehicle and different from the first image, on the basis of a state of the vehicle or position information of the vehicle.

In the display control device and the display control method according to the second aspect of the present technology, display of the first image on the front surface of the vehicle, the first image indicating a traveling direction of the vehicle, and display of the second image on the rear surface of the vehicle, the second image indicating the traveling direction of the vehicle and different from the first image, are controlled on the basis of the state of the vehicle or the position information of the vehicle.

### BRIEF DESCRIPTION OF DRAWINGS

FIG. 1 is a diagram illustrating a configuration example of an appearance of a cart (vehicle) on which an in-vehicle display device according to an embodiment of the present technology is mounted.

FIG. 2 is a diagram exemplifying images displayed on vehicle exterior display units when the cart of FIG. 1 moves forward.

FIG. 3 is a diagram exemplifying images displayed on the vehicle exterior display units when the cart of FIG. 1 moves backward.

FIG. 4 is a diagram exemplifying images displayed on the vehicle exterior display units when the cart of FIG. 1 turns right while moving forward.

FIG. 5 is a diagram exemplifying images displayed on the vehicle exterior display units when the cart of FIG. 1 turns left while moving forward.

FIG. 6 is a diagram exemplifying images displayed on the vehicle exterior display units when the cart of FIG. 1 decelerates.

FIG. 7 is a block diagram illustrating a configuration example of an in-vehicle display device according to an embodiment of the present technology.

FIG. 8 is a diagram exemplifying images displayed on the vehicle exterior display units when the cart of FIG. 1 moves forward in a second display form.

FIG. 9 is a diagram exemplifying images displayed on the vehicle exterior display units when the cart of FIG. 1 turns right while moving forward in the second display form.

FIG. 10 is a diagram exemplifying images displayed on the vehicle exterior display units when the cart of FIG. 1 moves forward in a third display form.

FIG. 11 is a diagram exemplifying images displayed on the vehicle exterior display units when the cart of FIG. 1 turns right while moving forward in the third display form.

### MODE FOR CARRYING OUT THE INVENTION

Hereinafter, an embodiment of the present technology will be described with reference to the drawings.

### Appearance and Interior of Cart

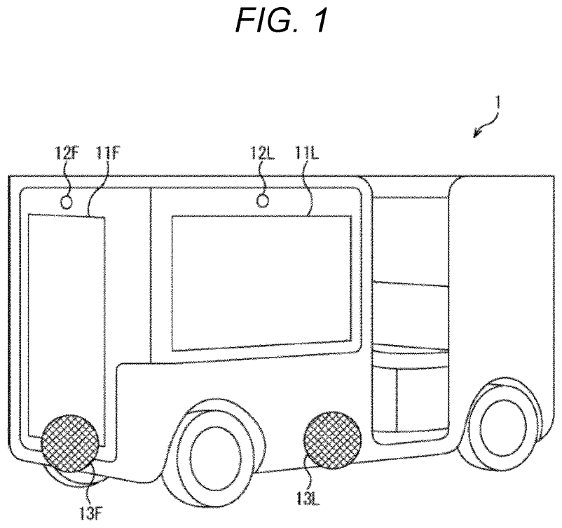

FIG. 1 is a diagram illustrating a configuration example of an appearance of a cart 1 on which an in-vehicle display device according to an embodiment of the present technology is mounted. FIG. 1 illustrates the appearance of the cart 1 as viewed diagonally from the left.

The cart 1 is a vehicle that can be moved by automated driving or remote operation. A person can get in the cart 1. The cart 1 may be driven by an occupant.

Examples of the cart 1 include an electric vehicle, such as an electric cart, moving with a motor. Note that the cart 1 according to the present embodiment is not limited to an electric vehicle.

The body of the cart 1 has a substantially rectangular parallelepiped shape. A vehicle exterior display unit 11F, a vehicle exterior display unit 11L, a vehicle exterior display unit 11R (not illustrated), and £ a vehicle exterior display unit 11B (not illustrated) are provided on a front surface, a left-side surface, a right-side surface, and a rear surface (back surface) of the cart 1, respectively. The vehicle exterior display units 11F to 11B include, for example, a thin display device (display) such as a liquid crystal display (LCD) or an organic EL panel. Note that the vehicle exterior display units 11F to 11B are also called front surface display unit 11F, left-side surface display unit 11L, right-side surface display unit 11R, and rear surface display unit 11B, respectively, corresponding to the surfaces of the cart 1 on which the vehicle exterior display units 11F to 11B are disposed.

As illustrated in FIG. 1, an entrance for a person to get in and out of is provided at a position close to the rear of the left-side surface of the body. No door is provided at the entrance. A similar entrance is also provided on the right-side surface of the body.

Furthermore, a camera 12F, a camera 12L, a camera 12R (not illustrated), and a camera 12B (not illustrated) are provided on the front surface, the left-side surface, the right-side surface, and the rear surface of the cart 1, respectively. Images of the front, left side, right side, and rear of the cart 1 are captured by the cameras 12F to 12B, respectively.

Moreover, a vehicle exterior speaker 13F, a vehicle exterior speaker 13L, a vehicle exterior speaker 13R (not illustrated), and a vehicle exterior speaker 13B (not illustrated) are provided on the front surface, the left-side surface, the right-side surface, and the rear surface of the cart 1, respectively. In FIG. 1, the vehicle exterior speaker 13F and the vehicle exterior speaker 13L are indicated by hatched circles, but the shapes and positions of the speakers are not limited to the shapes and positions illustrated in FIG. 1.

The cart 1 having such an appearance configuration is used for carrying a person and traveling on a circuit course set in a park, a theme park, and the like at a relatively low speed. The occupant can enjoy the presentation provided by the cart 1 while viewing the surrounding scenery.

### Display Example When Vehicle Moves Forward

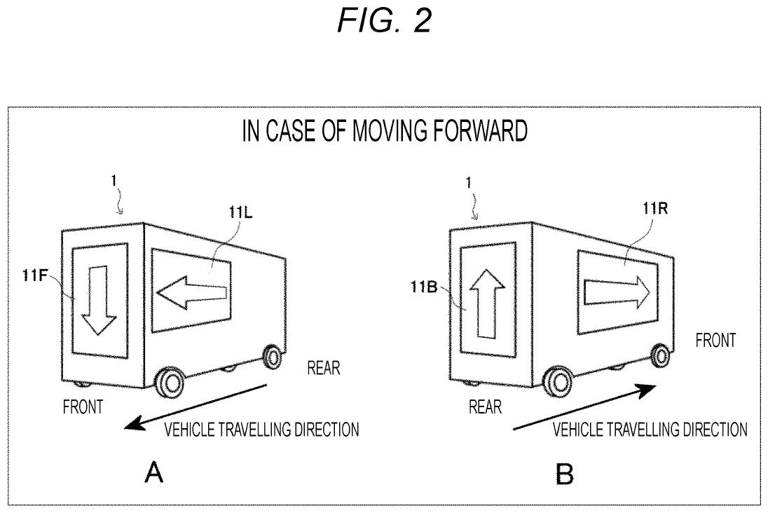

FIG. 2 is a diagram exemplifying images displayed on the vehicle exterior display units 11F to 11B when the cart 1 (vehicle) of FIG. 1 moves forward. FIG. 2 illustrates a front perspective view (A of FIG. 2) illustrating the cart 1 from diagonally front left and a rear perspective view (B of FIG. 2) illustrating the cart 1 from diagonally rear right. “When vehicle moves forward” may include a time when the vehicle starts to move forward in addition to a time when the vehicle is moving forward.

In A of FIG. 2, an arrow pointing vertically downward (an image of an arrow, hereinafter, simply referred to as arrow) is displayed on the front surface display unit 11F (first display unit) of the cart 1. An arrow pointing in the vehicle traveling direction is displayed on the left-side surface display unit 11L (third display unit) of the cart 1.

In B of FIG. 2, an arrow pointing vertically upward is displayed on the rear surface display unit 11B (second display unit) of the cart 1. An arrow pointing in the vehicle traveling direction is displayed on the right-side surface display unit 11R (fourth display unit) of the cart 1.

With this configuration, even when a pedestrian or the like views the vehicle from any direction of front, rear, left, and right, it is possible to intuitively recognize that the traveling direction of the vehicle is forward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

### Display Example When Vehicle Moves Backward

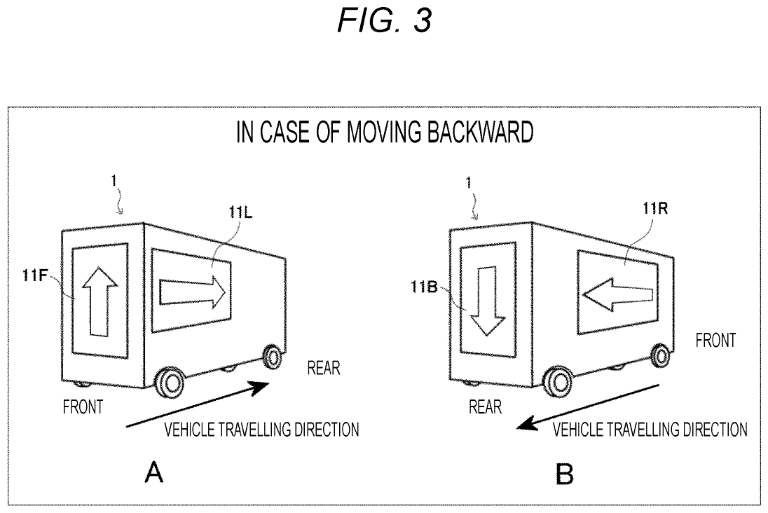

FIG. 3 is a diagram exemplifying images displayed on the vehicle exterior display units 11F to 11B when the cart 1 (vehicle) of FIG. 1 moves backward. FIG. 3 illustrates a front perspective view (A of FIG. 3) illustrating the cart 1 from diagonally front left and a rear perspective view (B of FIG. 3) illustrating the cart 1 from diagonally rear right. “When vehicle moves backward” may include a time when the vehicle starts to move backward in addition to a time when the vehicle is moving backward.

In A of FIG. 3, an arrow pointing vertically upward is displayed on the front surface display unit 11F (first display unit) of the cart 1. An arrow pointing in the vehicle traveling direction is displayed on the left-side surface display unit 11L (third display unit) of the cart 1.

In B of FIG. 3, an arrow pointing vertically downward is displayed on the rear surface display unit 11B (second display unit) of the cart 1. An arrow pointing in the vehicle traveling direction is displayed on the right-side surface display unit 11R (fourth display unit) of the cart 1.

With this configuration, even when a pedestrian or the like views the vehicle from any direction of front, rear, left, and right, it is possible to intuitively recognize that the traveling direction of the vehicle is backward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

### Display Example When Vehicle Turns Right While Moving Forward

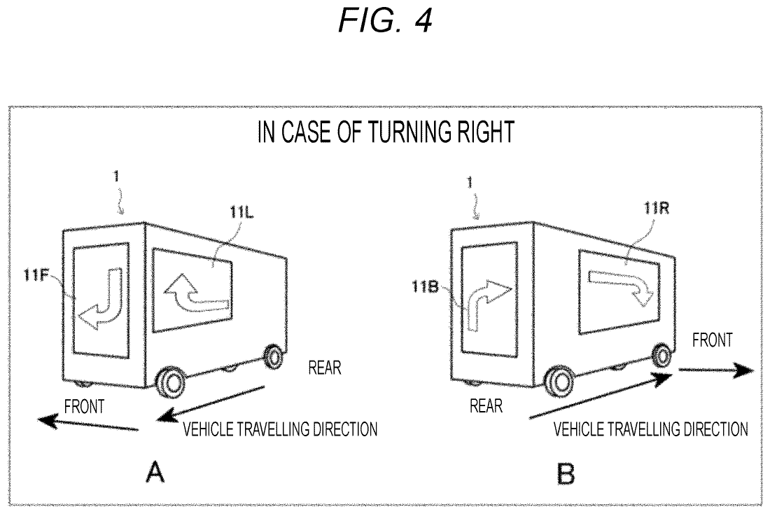

FIG. 4 is a diagram exemplifying images displayed on the vehicle exterior display units 11F to 11B when the cart 1 (vehicle) of FIG. 1 turns right while moving forward. FIG. 4 illustrates a front perspective view (A of FIG. 4) illustrating the cart 1 from diagonally front left and a rear perspective view (B of FIG. 4) illustrating the cart 1 from diagonally rear right. “When vehicle turns right while moving forward” may include a time when the vehicle starts to turn right while moving forward in addition to a time when the vehicle is turning right while moving forward.

In A of FIG. 4, an arrow formed by a straight line portion extending from the upper side to the lower side in the vertical direction and a curved line portion bending to the lower left is displayed on the front surface display unit 11F (first display unit) of the cart 1. On the left-side surface display unit 11L (third display unit) of the cart 1, an arrow formed by a straight line portion extending from the right to the left as viewed from a lateral side (left side) of the vehicle and a curved line portion bending to the upper left is displayed.

In B of FIG. 4, on the rear surface display unit 11B (second display unit) of the cart 1, an arrow formed by a straight line portion extending from the lower side to the upper side in the vertical direction and a curved line portion bending to the upper right (an arrow point-symmetrical to the arrow on the first display unit) is displayed. On the right-side surface display unit 11R (fourth display unit) of the cart 1, an arrow formed by a straight line portion extending from the left to the right as viewed from a lateral side (right side) of the vehicle and a curved line portion bending to the lower right (an arrow point-symmetrical to the arrow on the third display unit) is displayed.

With this configuration, even when a pedestrian or the like views the vehicle from any direction of front, rear, left, and right, it is possible to intuitively recognize that the traveling direction of the vehicle is the right turn while moving forward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

Not only the arrows but also characters may be displayed on the vehicle exterior display units 11F to 11B at the same time. For example, in a case of turning right, the vehicle exterior display units 11F to 11B display characters that clearly indicate the direction in which the vehicle moves, such as “This vehicle turns right”. Only “turn right” may cause surrounding vehicles to misunderstand that they are asked for a right turn, so the expression “This vehicle turns right” is desirable. In a case where the vehicle moves forward or backward, characters (“This vehicle moves forward”, “This vehicle moves backward”, and the like) may be similarly displayed on the vehicle exterior display units 11F to 11B. Furthermore, the same content as the characters to be displayed may be transmitted by sound to the outside of the vehicle, using the vehicle exterior speakers (13F, 13L, 13R, 13B).

### Display Example When Vehicle Turns Right While Moving Backward

In a case where the cart 1 (vehicle) of FIG. 1 turns right while moving backward, arrows point-symmetrical to the arrows of FIG. 4 are displayed on the vehicle exterior display units 11F to 11B, respectively. Description using the drawings is omitted. “When vehicle turns right while moving backward” may include a time when the vehicle starts to turn right while moving backward in addition to a time when the vehicle is turning right while moving backward.

With this configuration, even when a pedestrian or the like views the vehicle from any direction of front, rear, left, and right, it is possible to intuitively recognize that the traveling direction of the vehicle is the right turn while moving backward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

In the vehicle exterior display units 11F to 11B, not only an arrow but also characters (“This vehicle turns right” or the like) may be displayed at the same time as in the case where the vehicle turns right while moving forward, and a voice may be transmitted toward the outside of the vehicle.

### Display Example When Vehicle Turns Left While Moving Forward

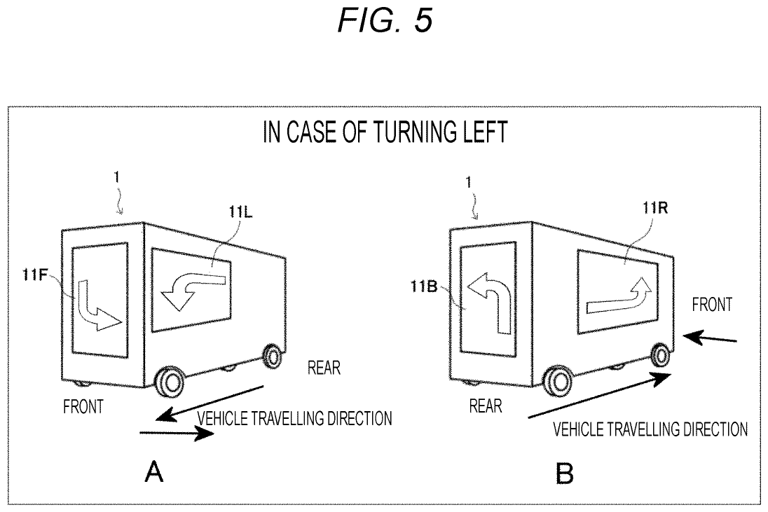

FIG. 5 is a diagram exemplifying images displayed on the vehicle exterior display units 11F to 11B when the cart 1 (vehicle) of FIG. 1 turns left while moving forward. FIG. 5 illustrates a front perspective view (A of FIG. 5) illustrating the cart 1 from diagonally front left and a rear perspective view (B of FIG. 5) illustrating the cart 1 from diagonally rear right. “When vehicle turns left while moving forward” may include a time when the vehicle starts to turn left while moving forward in addition to a time when the vehicle is turning left while moving forward.

In A of FIG. 5, an arrow formed by a straight line portion extending from the upper side to the lower side in the vertical direction and a curved line portion bending to the lower right is displayed on the front surface display unit 11F (first display unit) of the cart 1. On the left-side surface display unit 11L (third display unit) of the cart 1, an arrow formed by a straight line portion extending from the right to the left as viewed from a lateral side (left side) of the vehicle and a curved line portion bending to the lower left is displayed.

In B of FIG. 5, on the rear surface display unit 11B (second display unit) of the cart 1, an arrow formed by a straight line portion extending from the lower side to the upper side in the vertical direction and a curved line portion bending to the upper left (an arrow point-symmetrical to the arrow on the first display unit) is displayed. On the right-side surface display unit 11R (fourth display unit) of the cart 1, an arrow formed by a straight line portion extending from the left to the right as viewed from a lateral side (right side) of the vehicle and a curved line portion bending to the upper right (an arrow point-symmetrical to the arrow on the third display unit) is displayed.

With this configuration, even when a pedestrian or the like views the vehicle from any direction of front, rear, left, and right, it is possible to intuitively recognize that the traveling direction of the vehicle is the left turn while moving forward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

In the vehicle exterior display units 11F to 11B, not only an arrow but also characters (“This vehicle turns left” or the like) may be displayed at the same time as in the case where the vehicle turns right while moving forward, and a voice may be transmitted toward the outside of the vehicle.

### Display Example When Vehicle Turns Left While Moving Backward

In a case where the cart 1 (vehicle) of FIG. 1 turns left while moving backward, arrows point-symmetrical to the arrows of FIG. 5 are displayed on the vehicle exterior display units 11F to 11B, respectively. Description using the drawings is omitted. “When vehicle turns left while moving backward” may include a time when the vehicle starts to turn left while moving backward in addition to a time when the vehicle is turning left while moving backward.

With this configuration, even when a pedestrian or the like views the vehicle from any direction of front, rear, left, and right, it is possible to intuitively recognize that the traveling direction of the vehicle is the left turn while moving backward by the display method using arrows, and thus, the traveling direction of the vehicle is presented in an easy-to-understand manner.

Note that the arrow may be displayed in a planar manner or in a stereoscopic manner with a depth. The length of the arrow may be changed depending on the speed or acceleration of the vehicle. The higher the speed or acceleration of the vehicle is, the longer the arrow may be.

In the vehicle exterior display units 11F to 11B, not only an arrow but also characters (“This vehicle turns left” or the like) may be displayed at the same time as in the case where the vehicle turns right while moving forward, and a voice may be transmitted toward the outside of the vehicle.

### Display Example When Vehicle Decelerates

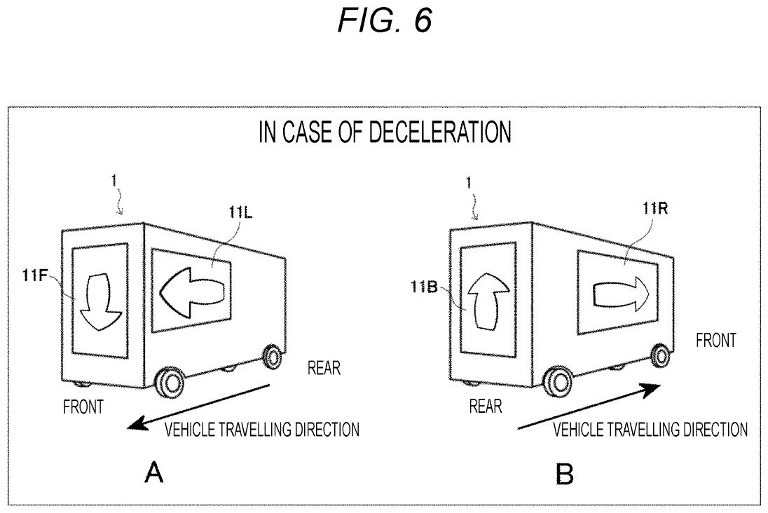

FIG. 6 is a diagram exemplifying images displayed on the vehicle exterior display units 11F to 11B when the cart 1 (vehicle) of FIG. 1 decelerates. FIG. 6 illustrates a front perspective view (A of FIG. 6) illustrating the cart 1 from diagonally front left and a rear perspective view (B of FIG. 6) illustrating the cart 1 from diagonally rear right. “When vehicle decelerates” may include a time when the vehicle starts to decelerate while moving forward in addition to a time when the vehicle is decelerating while moving forward. Note that, in FIG. 6, images displayed on the vehicle exterior display units 11F to 11B when the cart 1 moves forward are exemplified, such images may be applied not only to the case of moving forward but also to the cases of moving backward or the like in a similar manner.

The arrows displayed on the vehicle exterior display units 11F to 11B in A and B of FIG. 6 and the arrows in the case of FIG. 2 that are displayed on the vehicle exterior display units 11F to 11B when the cart 1 moves forward have the same direction.

However, at the time of deceleration, arrows with a crushed expression are displayed as compared with the arrows in the case of FIG. 2. That is, each arrow has a line segment portion (shaft portion) formed of a straight line and a curved line, and an arrowhead portion (arrow head portion). The arrow displayed at the time of deceleration in FIG. 6 has a shape in which a length of the shaft portion is shorter and a width in the vicinity of the center of the shaft portion bulges (widens) than the vicinity of end points (start point and end point) as compared with the arrow in the case of FIG. 2. Similarly, the arrow head portion has a shape with a short length and a large width (large tip angle).

As a representation of the crushed arrow, the tip of the arrow head portion may be rounded. The arrow displayed at the time of deceleration may include any one or more expressions of shortening the length of the shaft portion, bulging the width of the shaft portion, shortening the length of the arrow head portion, widening the width of the arrow head portion, and rounding the tip of the arrow head portion, as compared with the arrow in the case of FIG. 2. In a case where the cart 1 completely stops, the shaft portion of the arrow may be eliminated, and an arrow of only the arrow head portion (for example, only a triangular image) may be displayed, or an image of a figure, such as an annular mark, representing a stop may be displayed.

With this configuration, even when a pedestrian or the like views the vehicle from any direction of front, rear, left, and right, it is possible to intuitively recognize that the vehicle decelerates by the display method using arrows, and thus, the deceleration as well as the traveling direction of the vehicle is presented in an easy-to-understand manner.

Note that not only the arrows but also characters may be displayed on the vehicle exterior display units 11F to 11B at the same time as in the case of turning right while moving forward. For example, in a case of deceleration, the vehicle exterior display units 11F to 11B display characters that clearly indicate deceleration of the vehicle, such as “This vehicle decelerates”. Furthermore, a voice may be transmitted toward the outside of the vehicle.

### Configuration Example of In-Vehicle Display Device According to One Embodiment of Present Technology

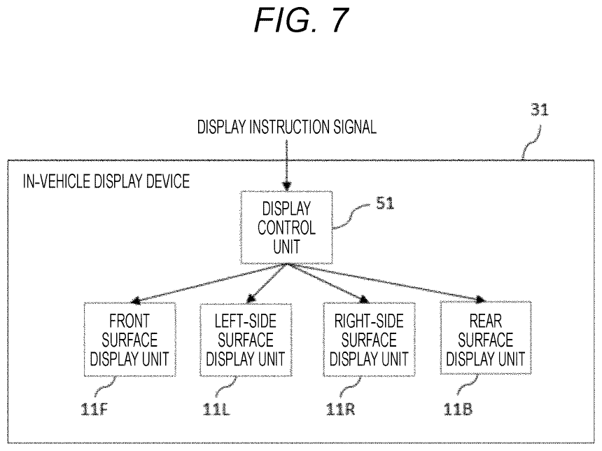

FIG. 7 is a block diagram illustrating a configuration example of an in-vehicle display device according to an embodiment of the present technology. In FIG. 7, a vehicle display device 31 includes the front surface display unit 11F, the left-side surface display unit 11L, the right-side surface display unit 11R, and the rear surface display unit 11B which are the vehicle exterior display units 11F to 11B described above, and a display control unit 51.

On the basis of a display instruction signal, the display control unit 51 generates an image of an arrow or the like as illustrated in FIGS. 2 to 6 to be displayed on each of the front surface display unit 11F, the left-side surface display unit 11L, the right-side surface display unit 11R, and the rear surface display unit 11B, and supplies the image to each of the front surface display unit 11F, the left-side surface display unit 11L, the right-side surface display unit 11R, and the rear surface display unit 11B.

The display instruction signal is generated depending on, for example, a state of the vehicle (cart 1). More specifically, the display instruction signal is generated depending on a driving state and a blinker operation state of the vehicle, and the like. For example, in a case where the vehicle is moving forward, a display instruction signal indicating that the vehicle is moving forward is provided to the display control unit 51. When the display instruction signal indicating forward movement is given, the display control unit 51 generates an image of an arrow at the time of forward movement illustrated in FIG. 2 and displays the image on each of the vehicle exterior display units 11F to 11B. In a case where characters are displayed, an image of the characters is also generated (a similar manner applies hereinafter). In this state, in a case where the right-turn blinker is operated, a display instruction signal indicating right turn is provided to the display control unit 51. When the display instruction signal indicating right turn is given, the display control unit 51 generates an image of an arrow at the time of turning right while moving forward illustrated in FIG. 4, and changes the image of the arrow in FIG. 2 to display the image of the arrow in FIG. 4 on each of the vehicle exterior display units 11F to 11B.

As another example of the display instruction signal, in a case where a shift lever is at a drive position, a display instruction signal indicating that the vehicle is moving forward is provided to the display control unit 51. In a case where the shift lever is operated to a reverse position, a display instruction signal indicating that the vehicle is moving backward (or starting moving backward) is provided to the display control unit 51. When the display instruction signal indicating the vehicle moves backward is given, the display control unit 51 generates an image of an arrow at the time of backward movement illustrated in FIG. 3 and displays the image on each of the vehicle exterior display units 11F to 11B.

The display instruction signal may be generated depending on the position information of the vehicle. For example, in a case where a traveling route is set in advance, the display instruction signal indicating that the vehicle turns right when approaching a right turn point may be provided to the display control unit 51. The vehicle position information may be acquired by a global navigation satellite system (GNSS) or the like, or may be acquired by reading a radio frequency identifier (RFID) embedded in a road.

### Another Display Form of Vehicle Traveling Direction (Second Display Form)

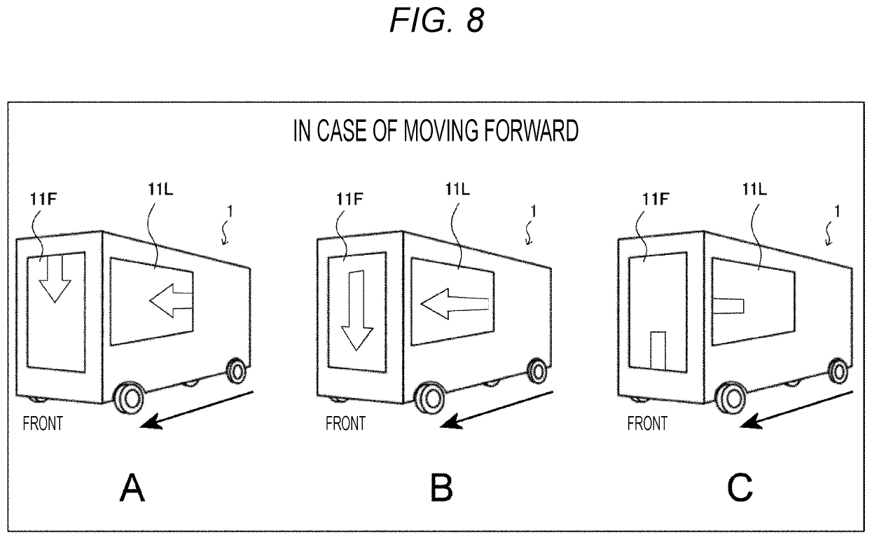

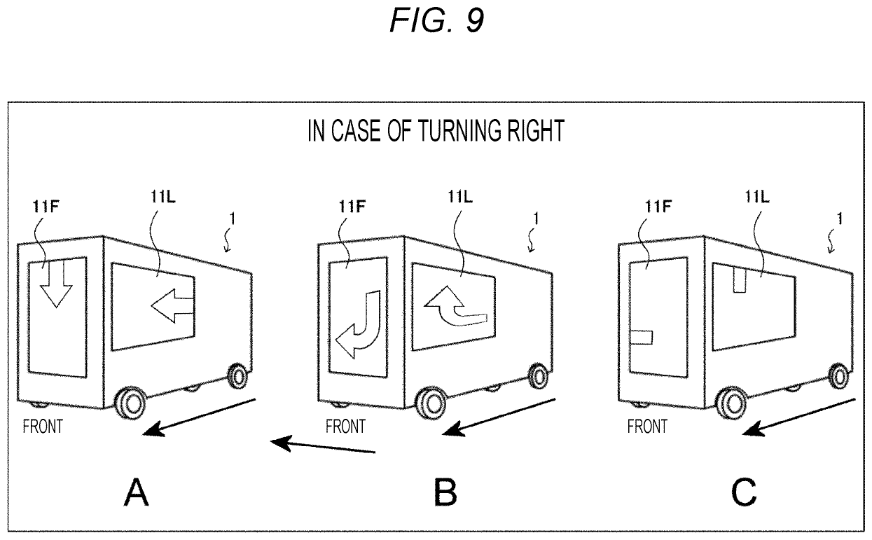

FIGS. 8 and 9 are diagrams for explaining another display form (second display form) of the vehicle traveling direction displayed on the vehicle exterior display units 11F to 11B by the cart 1 (vehicle) of FIG. 1. In the display form described with reference to FIGS. 2 to 6, an arrow indicating the vehicle traveling direction is displayed in a stationary state on the screen of each of the vehicle exterior display units 11F to 11B. In the second display form, the arrow moves in the traveling direction (direction of the arrow) on the screen of each of the vehicle exterior display units 11F to 11B.

### Display Example When Vehicle Moves Forward (or Backward)

A to C of FIG. 8 illustrate front perspective views of the cart 1 in chronological order, and exemplify images displayed on the vehicle exterior display units 11F and 11L in the second display form when the cart 1 moves forward. In A to C of FIG. 8, the front surface display unit 11F of the cart 1 displays an image that changes with time such that an arrow (arrow image) pointing vertically downward moves on the screen, and the left-side surface display unit 11L displays an image that changes with time such that an arrow (arrow image) directed leftward that is a vehicle traveling direction moves on the screen. Note that, in a case where the terms “upper”, “lower”, “left”, or “right” are used with respect to images (arrows and the like), screens, and the like displayed on the vehicle exterior display units 11F to 11B, those terms shall be used to indicate the upper side, the lower side, the left side, or the right side when each screen is viewed from the front.

The arrow displayed on the front surface display unit 11F moves in a direction in which the arrow points, that is, in the downward direction from the upper part to the lower part of the screen. At an initial stage when the arrow appears on the screen, a part of the tip side (arrowhead side) of the arrow appears from the upper part of the screen as illustrated in A of FIG. 8. Thereafter, the arrow moves downward on the screen, and the entire arrow is displayed in the screen as illustrated in B of FIG. 8. If the arrow further moves downward, only a part of a base end side of the arrow (a part of the line segment portion) is displayed at the lower part of the screen as illustrated in C of FIG. 8, and the arrow finally disappears from the screen. As described above, in the front surface display unit 11F of the cart 1, the arrow having appeared from the upper part of the screen moves toward the lower part of the screen and disappears from the lower part of the screen. The arrow disappears from the lower part of the screen and then appears again from the upper part of the screen. In the front surface display unit 11F, such display of the arrow is repeated. Note that before the arrow disappears from the screen, the next arrow may appear from the upper part of the screen. Furthermore, the repetition of the display of the arrow that appears and disappears may be changed depending on a moving speed of the vehicle or the like.

The arrow displayed on the left-side surface display unit 11L moves in a direction in which the arrow points, that is, in the leftward direction from the right part to the left part of the screen. At an initial stage when the arrow appears on the screen, a part of the tip side of the arrow appears from the right part of the screen as illustrated in A of FIG. 8. Thereafter, the arrow moves leftward on the screen, and the entire arrow is displayed in the screen as illustrated in B of FIG. 8. If the arrow further moves leftward, only a part of a base end side of the arrow is displayed at the left part of the screen as illustrated in C of FIG. 8, and the arrow finally disappears from the screen. As described above, in the left-side surface display unit 11L of the cart 1, the arrow having appeared from the right part of the screen moves toward the left part of the screen and disappears from the left part of the screen. The arrow disappears from the right part of the screen and then appears again from the right part of the screen. In the left-side surface display unit 11L, such display of the arrow is repeated. Note that before the arrow disappears from the screen, the next arrow may appear from the right part of the screen. Furthermore, the repetition of the display of the arrow that appears and disappears may be changed depending on a moving speed of the vehicle or the like.

Although detailed description using the drawings is omitted, when the cart 1 moves forward, on the rear surface display unit 11B, an arrow pointing upward is displayed so as to move upward from the lower part of the screen toward the upper part of the screen. On the right-side surface display unit 11R, an arrow pointing rightward, which is the vehicle traveling direction, is displayed so as to move rightward from the left part of the screen toward the right part of the screen. Furthermore, similarly to the relationship between FIGS. 2 and 3, when the cart 1 moves forward and backward, the displays of the front surface display unit 11F and the rear surface display unit 11B are switched, and the displays of the left-side surface display unit 11L and the right-side surface display unit 11R are switched.

With the display of the vehicle traveling direction in the second display form when the vehicle moves forward and backward, even when a pedestrian or the like views the vehicle from any direction of front, rear, left, and right, it is possible to intuitively recognize that the traveling direction of the vehicle is moving forward or backward by the display method using arrows and the moving direction of the arrow, so that the traveling direction of the vehicle is presented in an easy-to-understand manner.

Note that, in the second display form, the shape of the arrow may be changed as in FIG. 6 when the vehicle decelerates. The arrow may be displayed in a planar manner or in a stereoscopic manner with a depth. A length of the arrow or a moving speed of the arrow may be changed depending on the speed or acceleration of the vehicle. For example, the higher the speed or acceleration of the vehicle is, the longer the arrow may be, or the higher the moving speed of the arrow may be.

### Display Example When Vehicle Turns Right (or Left) While Moving Forward (or Backward)

A to C of FIG. 9 illustrate front perspective views of the cart 1 in chronological order, and exemplify images displayed on the vehicle exterior display units 11F and 11L in the second display form when the cart 1 turns right while moving forward. In A to C of FIG. 9, an image that changes with time by changing the direction from the downward direction to the leftward direction while the arrow (arrow image) moves on the screen is displayed on the front surface display unit 11F of the cart 1, and an image that changes with time by changing the direction from the leftward direction to the upward direction while the arrow moves on the screen is displayed on the left-side surface display unit 11L.

The arrow displayed on the front surface display unit 11F appears, as an arrow pointing downward, from the upper part of the screen. At an initial stage when the arrow appears on the screen, a part of the tip side (arrowhead side) of the arrow appears from the upper part of the screen as illustrated in A of FIG. 9. Thereafter, the arrow moves downward on the screen, and after the entire arrow is displayed on the screen, the arrow is changed to a curved arrow as in B of FIG. 9, similarly to FIG. 4. The curved arrow is an arrow formed of a straight line portion extending downward from the upper side and a curved line portion bending to the lower left. That is, with respect to the arrow directed downward as a whole, the arrow is changed to an arrow in which the arrowhead portion (arrow head portion) points leftward and the arrowhead side of the line segment portion (shaft portion) linearly extending downward from the base end side is curved to the lower left. After a further lapse of time, the arrow is changed to an arrow entirely pointing leftward. Thereafter, the arrow moves leftward, only a part of a base end side of the arrow (a part of the line segment portion) is displayed at the left part of the screen as illustrated in C of FIG. 9, and the arrow finally disappears from the screen. As described above, in the front surface display unit 11F of the cart 1, the arrow having appeared from the upper part of the screen moves toward the lower part of the screen, moves while changing the moving direction to the direction to the left part of the screen on the way, and disappears from the left part of the screen. The arrow disappears from the left part of the screen and then appears again from the upper part of the screen. Note that before the arrow disappears from the screen, the next arrow may appear from the upper part of the screen. In the front surface display unit 11F, such display of the arrow is repeated. Note that after the arrow pointing downward appears from the upper part of the screen and moves downward, the arrowhead portion (arrow head portion) of the arrow may gradually or instantaneously change its direction to the leftward direction while moving in the direction of the arrowhead, and the line segment portion (shaft portion) may follow the arrowhead portion while being deformed so as to pass the same trajectory as the arrowhead portion. Furthermore, the repetition of the display of the arrow that appears and disappears may be changed depending on a moving speed of the vehicle or the like.

The arrow displayed on the left-side surface display unit 11L appears, as an arrow pointing leftward, from the right part of the screen. At an initial stage when the arrow appears on the screen, a part of the tip side (arrowhead side) of the arrow appears from the right part of the screen as illustrated in A of FIG. 9. Thereafter, the arrow moves leftward on the screen, and after the entire arrow is displayed on the screen, the arrow is changed to a curved arrow as in B of FIG. 9, similarly to FIG. 4. The curved arrow is an arrow formed of a straight line portion extending leftward from the right and a curved line portion bending to the upper left. That is, with respect to the arrow pointing leftward as a whole, the arrow is changed to an arrow in which the arrowhead portion points upward and the arrowhead side of the line segment portion linearly extending leftward from the base end side is curved to the upper left. After a further lapse of time, the arrow is changed to an arrow entirely pointing upward. Thereafter, the arrow moves upward, only a part of a base end side of the arrow (a part of the line segment portion) is displayed at the upper part of the screen as illustrated in C of FIG. 9, and the arrow finally disappears from the screen. As described above, in the left-side surface display unit 11L of the cart 1, the arrow having appeared from the right part of the screen moves toward the left part of the screen, moves while changing the moving direction to the direction to the upper part of the screen on the way, and disappears from the upper part of the screen. The arrow disappears from the upper part of the screen and then appears again from the right part of the screen. Note that before the arrow disappears from the screen, the next arrow may appear from the right part of the screen. In the left-side surface display unit 11L, such display of the arrow is repeated. Furthermore, the repetition of the display of the arrow that appears and disappears may be changed depending on a moving speed of the vehicle or the like. After the arrow pointing leftward appears from the right part of the screen and moves leftward, the arrowhead portion (arrow head portion) of the arrow may gradually or instantaneously change its direction to the upward direction while moving in the direction of the arrowhead, and the line segment portion (shaft portion) may follow the arrowhead portion while being deformed so as to pass the same trajectory as the arrowhead portion.

Although detailed description using the drawings is omitted, when the cart 1 turns right while moving forward, an arrow changing the direction from the downward direction to the rightward direction while moving on the screen is displayed on the rear surface display unit 11B, and an arrow changing the direction from the leftward direction to the downward direction while moving on the screen is displayed on the right-side surface display unit 11R. Furthermore, similarly to the relationship between FIGS. 2 and 3, when the cart 1 turns right or left while moving forward, the displays of the front surface display unit 11F and the rear surface display unit 11B are horizontally reversed each other, and the displays of the left-side surface display unit 11L and the right-side surface display unit 11R are vertically reversed each other. In a case where the cart 1 moves forward and backward in right turn or left turn, the displays of the front surface display unit 11F and the rear surface display unit 11B are switched, and the displays of the left-side surface display unit 11L and the right-side surface display unit 11R are switched. Note that right turn (or left turn) while moving backward means right turn (or left turn) with respect to the vehicle traveling direction.

With the display of the vehicle traveling direction in the second display form when the vehicle turns right and left while moving forward, even when a pedestrian or the like views the vehicle from any direction of front, rear, left, and right, it is possible to intuitively recognize that the traveling direction of the vehicle is turning right or left while moving forward by the display method using arrows and the moving direction of the arrow, so that the traveling direction of the vehicle is presented in an easy-to-understand manner.

Note that, in the second display form, the shape of the arrow may be changed as in FIG. 6 when the vehicle decelerates. The arrow may be displayed in a planar manner or in a stereoscopic manner with a depth. A length of the arrow or a moving speed of the arrow may be changed depending on the speed or acceleration of the vehicle. For example, the higher the speed or acceleration of the vehicle is, the longer the arrow may be, or the higher the moving speed of the arrow may be. In the vehicle exterior display units 11F to 11B, not only an arrow but also characters (“This vehicle turns right” or the like) may be displayed at the same time, and a voice may be transmitted toward the outside of the vehicle.

### Another Display Form of Vehicle Traveling Direction (Third Display Form)

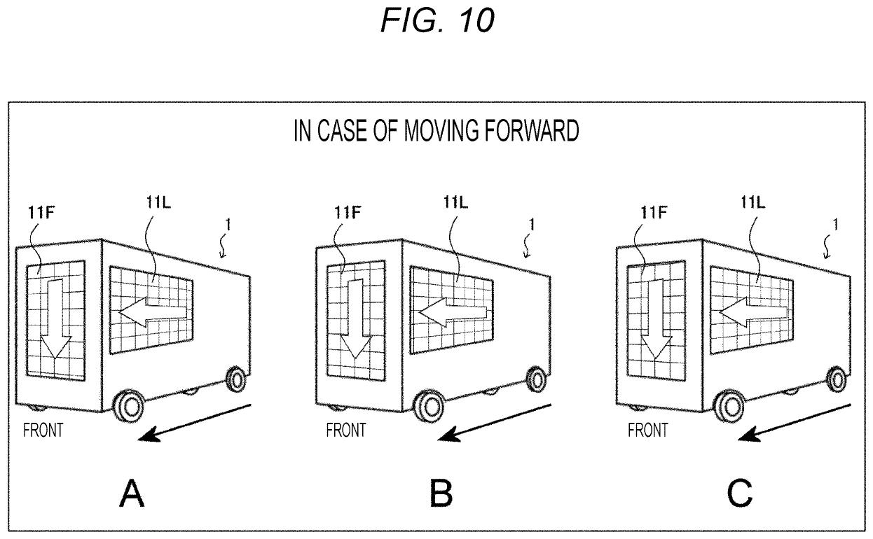

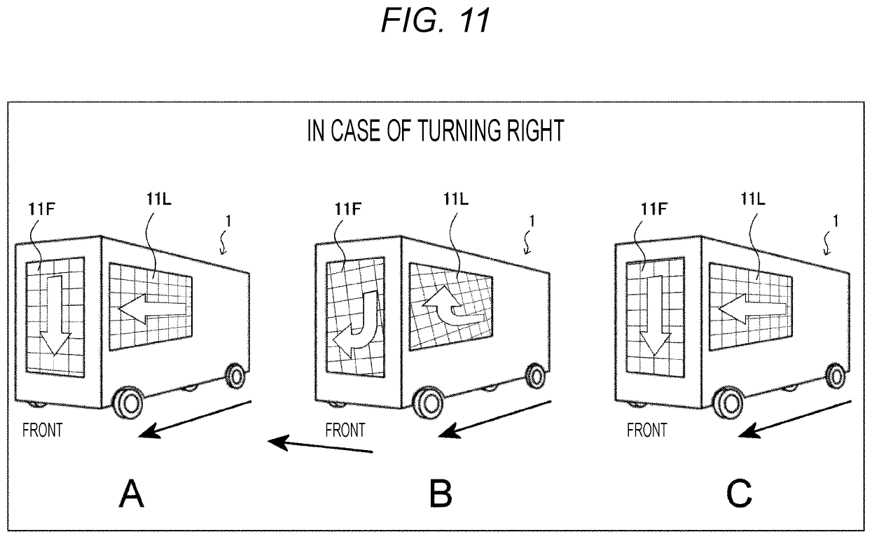

FIGS. 10 and 11 are diagrams for explaining another display form (third display form) of the traveling direction displayed on the vehicle exterior display units 11F to 11B by the cart 1 (vehicle) of FIG. 1. In the second display form described with reference to FIGS. 9 and 10, an arrow indicating the vehicle traveling direction moves on the screen of each of the vehicle exterior display units 11F to 11B. In the third display form, an arrow indicating the vehicle traveling direction is displayed at substantially the same position on the screen, and an image that changes with time is displayed such that the background image moves in a direction opposite to the direction in which the arrow points.

### Display Example When Vehicle Moves Forward (Backward)

A to C of FIG. 10 illustrate front perspective views of the cart 1 in chronological order, and exemplify images displayed on the vehicle exterior display units 11F and 11L in the third display form when the cart 1 moves forward. In A to C of FIG. 10, an arrow (arrow image) pointing downward is displayed at a certain position on the screen on the front surface display unit 11F of the cart 1. On the other hand, a background (background image) indicated by a grid on the front surface display unit 11F moves in the upward direction opposite to the downward direction in which the arrow points. In the second display form, after the arrow moves out of the screen, it is necessary to display the arrow again, and there is a timing at which the arrow is not displayed on the screen. In the third display form, since the arrow continues to be displayed without disappearing from the screen, a pedestrian or the like around the cart 1 can always recognize the traveling direction of the cart 1. This also further simplifies the animation.

On the left-side surface display unit 11L, an arrow (arrow image) pointing the leftward direction which is the vehicle traveling direction is displayed at a certain position on the image. On the other hand, a background (background image) indicated by a grid on the left-side surface display unit 11L moves on the screen in the right direction opposite to the leftward direction in which the arrow points. Therefore, it is displayed that the vehicle is moving leftward without the arrow disappearing from the screen, and it is displayed that the cart 1 is moving forward. Note that, in A to C of FIG. 10, the grid displayed as the background on the front surface display unit 11F and the left-side surface display unit 11L is an example, and the background may be an image of any form (a similar manner applies to the background in FIG. 11 below, for example).

Although detailed description using the drawings is omitted, when the cart 1 moves forward, an arrow pointing upward is displayed at a certain position and a background moving downward is displayed, on the rear surface display unit 11B. On the right-side surface display unit 11R, an arrow pointing rightward is displayed at a certain position on the screen, and a background moving leftward is displayed.

With the display of the vehicle traveling direction in the third display form when the vehicle moves forward and backward, even when a pedestrian or the like views the vehicle from any direction of front, rear, left, and right, it is possible to intuitively recognize that the traveling direction of the vehicle is moving forward or backward by the display method using arrows and the moving direction of the background of the arrow, so that the traveling direction of the vehicle is presented in an easy-to-understand manner.

Note that, in the third display form, the shape of the arrow may be changed as in FIG. 6 when the vehicle decelerates. The arrow may be displayed in a planar manner or in a stereoscopic manner with a depth. A length of the arrow or a moving speed of the background may be changed depending on the speed or acceleration of the vehicle. For example, the higher the speed or acceleration of the vehicle is, the longer the arrow may be, or the higher the moving speed of the background may be.

### Display Example When Vehicle Turns Right (or Left) While Moving Forward (or Backward)

A to C of FIG. 11 illustrate front perspective views of the cart 1 in chronological order, and exemplify images displayed on the vehicle exterior display units 11F and 11L in the third display form when the cart 1 turns right while moving forward. In A to C of FIG. 11, an arrow pointing downward and an arrow curving from the downward direction to the lower left direction (or the leftward direction) are alternately displayed at a certain position on the screen on the front surface display unit 11F of the cart 1. In A of FIG. 11, the arrow on the front surface display unit 11F points downward. In B of FIG. 11 after the lapse of time, the arrow on the front surface display unit 11F is changed to an arrow in which the arrowhead portion (arrow head portion) points the lower left direction (or the leftward direction) and the arrowhead side of the line segment portion (shaft portion) linearly extending downward from the base end side is curved to the lower left. In C of FIG. 11 after a further lapse of time, the arrow on the front surface display unit 11F is changed to an arrow pointing downward as in A of FIG. 11. On the other hand, the background indicated by the grid on the front surface display unit 11F moves in a direction opposite to the direction in which the arrow points (the direction of the arrowhead), and in A and C of FIG. 11, the background on the front surface display unit 11F moves in the upward direction opposite to the direction in which the arrow points. In B of FIG. 11, the background on the front surface display unit 11F is rotationally moved in the upper right direction (or the right direction) opposite to the direction in which the arrow points. In the front surface display unit 11F, display switching between such an arrow pointing downward and a curved arrow and switching of the moving direction of the background are repeated. Note that, in switching the display from the arrow directed downward to the curved arrow, the direction of the arrowhead portion (arrow head portion) of the arrow may be gradually changed from the downward direction to the leftward direction, and the rotational movement of the background may be gradually changed depending on the direction of the arrowhead, or the direction of the arrowhead portion (arrow head portion) of the arrow may be instantaneously changed from the downward direction to the leftward direction.

In A to C of FIG. 11, an arrow pointing leftward and an arrow curving from the leftward direction to the upper left direction (or the upward direction) are alternately displayed at a certain position on the screen on the left-side surface display unit 11L of the cart 1. In A of FIG. 11, the arrow on the left-side surface display unit 11L points leftward. In B of FIG. 11 after the lapse of time, the arrow on the left-side surface display unit 11L is changed to an arrow in which the arrowhead portion (arrow head portion) points the upper left direction (or the upward direction) and the arrowhead side of the line segment portion (shaft portion) linearly extending leftward from the base end side is curved to the upper left. In C of FIG. 11 after a further lapse of time, the arrow on the left-side surface display unit 11L is changed to an arrow pointing leftward as in A of FIG. 11. On the other hand, the background indicated by the grid on the left-side surface display unit 11L moves in a direction opposite to the direction in which the arrow points (the direction of the arrowhead), and in A and C of FIG. 11, the background on the left-side surface display unit 11L moves in the rightward direction opposite to the direction in which the arrow points. In B of FIG. 11, the background on the left-side surface display unit 11L is rotationally moved in the lower right direction (or the downward direction) opposite to the direction in which the arrow points. In the left-side surface display unit 11L, display switching between such arrow pointing leftward and the curved arrow and switching of the moving direction of the background are repeated. Note that, in switching the display from the arrow pointing leftward to the curved arrow, the direction of the arrowhead portion (arrow head portion) of the arrow may be gradually changed from the leftward direction to the upward direction, and the rotational movement of the background may be gradually changed depending on the direction of the arrowhead, or the direction of the arrowhead portion (arrow head portion) of the arrow may be instantaneously changed from the leftward direction to the upward direction.

Although detailed description using the drawings is omitted, when the cart 1 turns right while moving forward, an arrow pointing upward and an arrow curving from the upward direction to the upper right direction (or the rightward direction) are switched and displayed on the rear surface display unit 11B, and accordingly, the moving direction of the background is changed to be opposite to the arrow. An arrow pointing rightward and an arrow curving from the right to the lower right (or downward) are switched and displayed on the right-side surface display unit 11R, and accordingly, the rotational movement direction of the background is changed to be the opposite direction to the arrow. Furthermore, similarly to the relationship between FIGS. 2 and 3, when the cart 1 turns right or left while moving forward, the displays of the front surface display unit 11F and the rear surface display unit 11B are horizontally reversed each other, and the displays of the left-side surface display unit 11L and the right-side surface display unit 11R are vertically reversed each other. In a case where the cart 1 moves forward and backward in right turn or left turn, the displays of the front surface display unit 11F and the rear surface display unit 11B are switched, and the displays of the left-side surface display unit 11L and the right-side surface display unit 11R are switched.

With the display of the vehicle traveling direction in the third display form when the vehicle turns right and left while moving forward, even when a pedestrian or the like views the vehicle from any direction of front, rear, left, and right, it is possible to intuitively recognize that the traveling direction of the vehicle is turning right or left while moving forward by the display method using arrows and the moving direction of the background of the arrow, so that the traveling direction of the vehicle is presented in an easy-to-understand manner.

Note that, in the third display form, the shape of the arrow may be changed as in FIG. 6 when the vehicle decelerates. The arrow may be displayed in a planar manner or in a stereoscopic manner with a depth. A length of the arrow, a moving speed of the arrow or a moving speed of the background may be changed depending on the speed or acceleration of the vehicle. For example, the higher the speed or acceleration of the vehicle is, the longer the arrow may be, or the higher the moving speed of the arrow or the moving speed of the background may be. In the vehicle exterior display units 11F to 11B, not only an arrow but also characters (“This vehicle turns right” or the like) may be displayed at the same time, and a voice may be transmitted toward the outside of the vehicle.

The present technology can also have the following configurations.
(1)

An in-vehicle display device including:
a first display unit mounted on a front surface of a vehicle;
a second display unit mounted on a rear surface of the vehicle; and
a display control unit that performs control to display a first image on the first display unit, the first image indicating a traveling direction of the vehicle, and performs control to display a second image on the second display unit, the second image indicating the traveling direction of the vehicle and different from the first image, on the basis of a state of the vehicle or position information of the vehicle.
(2)

The in-vehicle display device according to (1), in which the display control unit controls the first display unit and the second display unit on the basis of a state of the vehicle.
(3)

The in-vehicle display device according to (1) or (2), in which the display control unit controls the first display unit and the second display unit on the basis of a blinker operation state and a driving state of the vehicle.
(4)

The in-vehicle display device according to (1), in which the display control unit controls the first display unit and the second display unit on the basis of the position information of the vehicle.
(5)

The in-vehicle display device according to any one of (1) to (4), in which the first image and the second image are arrows.
(6)

The in-vehicle display device according to (5), in which the arrow of the second image is an arrow point-symmetrical to the arrow of the first image.
(7)

The in-vehicle display device according to (5) or (6), in which the arrow of the first image and the arrow of the second image each have a straight line portion and a curved line portion.
(8)

The in-vehicle display device according to any one of (1) to (7), further including:
a third display unit mounted on a left-side surface of the vehicle; and
a fourth display unit mounted on a right-side surface of the vehicle, in which
the display control unit performs control to display a third image on the third display unit, the third image indicating the traveling direction of the vehicle, and performs control to display a fourth image on the fourth display unit, the fourth image indicating the traveling direction of the vehicle and different from the third image, on the basis of the state or the position information.
(9)

The in-vehicle display device according to (8), in which the third image and the fourth image are arrows.
(10)

The in-vehicle display device according to (9), in which the arrow of the fourth image is an arrow point-symmetrical to the arrow of the third image.
(11)

The in-vehicle display device according to (9) or (10), in which the arrow of the third image and the arrow of the fourth image each have a straight line portion and a curved line portion.
(12)

The in-vehicle display device according to any one of (1) to (11), in which the first image and the second image are changed on the basis of a speed or an acceleration of the vehicle.
(13)

The in-vehicle display device according to any one of (1) to (12), in which the first image and the second image change with time.
(14)

The in-vehicle display device according to (13), in which
the first image and the second image each include an arrow and a background image, and
the display control unit changes a position of each of the arrows with time.
(15)

The in-vehicle display device according to (13), in which
the first image and the second image each include an arrow and a background image, and
the display control unit changes the background image with time.
(16)

A display control device including a display control unit that controls display of a first image on a front surface of the vehicle, the first image indicating a traveling direction of a vehicle, and controls display of a second image on a rear surface of the vehicle, the second image indicating the traveling direction of the vehicle and different from the first image, on the basis of a state of the vehicle or position information of the vehicle.
(17)

A display control method of a display control device including a display control unit, the display control method including causing the display control unit to control display of a first image on a front surface of the vehicle, the first image indicating a traveling direction of a vehicle, and controls display of a second image on a rear surface of the vehicle, the second image indicating the traveling direction of the vehicle and different from the first image, on the basis of a state of the vehicle or position information of the vehicle.

### REFERENCE SIGNS LIST

1 Cart
11B, 11F, 11L, 11R Vehicle exterior display unit
31 Vehicle display device
51 Display control device

1. An in-vehicle display device comprising:
a first display unit mounted on a front surface of a vehicle;
a second display unit mounted on a rear surface of the vehicle; and
a display control unit that performs control to display a first image on the first display unit, the first image indicating a traveling direction of the vehicle, and performs control to display a second image on the second display unit, the second image indicating the traveling direction of the vehicle and different from the first image, on a basis of a state of the vehicle or position information of the vehicle.

2. The in-vehicle display device according to claim 1, wherein the display control unit controls the first display unit and the second display unit on the basis of the state of the vehicle.

3. The in-vehicle display device according to claim 2, wherein the display control unit controls the first display unit and the second display unit on a basis of a blinker operation state and a driving state of the vehicle.

4. The in-vehicle display device according to claim 1, wherein the display control unit controls the first display unit and the second display unit on the basis of the position information of the vehicle.

5. The in-vehicle display device according to claim 1, wherein the first image and the second image are arrows.

6. The in-vehicle display device according to claim 5, wherein the arrow of the second image is an arrow point-symmetrical to the arrow of the first image.

7. The in-vehicle display device according to claim 6, wherein the arrow of the first image and the arrow of the second image each have a straight line portion and a curved line portion.

8. The in-vehicle display device according to claim 1, further comprising:
a third display unit mounted on a left-side surface of the vehicle; and
a fourth display unit mounted on a right-side surface of the vehicle,
wherein the display control unit performs control to display a third image on the third display unit, the third image indicating the traveling direction of the vehicle, and performs control to display a fourth image on the fourth display unit, the fourth image indicating the traveling direction of the vehicle and different from the third image, on the basis of the state or the position information.

9. The in-vehicle display device according to claim 8, wherein the third image and the fourth image are arrows.

10. The in-vehicle display device according to claim 9, wherein the arrow of the fourth image is an arrow point-symmetrical to the arrow of the third image.

11. The in-vehicle display device according to claim 10, wherein the arrow of the third image and the arrow of the fourth image each have a straight line portion and a curved line portion.

12. The in-vehicle display device according to claim 1, wherein the first image and the second image are changed on a basis of a speed or an acceleration of the vehicle.

13. The in-vehicle display device according to claim 1, wherein the first image and the second image change with time.

14. The in-vehicle display device according to claim 13, wherein
the first image and the second image each include an arrow and a background image, and
the display control unit changes a position of each of the arrows with time.

15. The in-vehicle display device according to claim 13, wherein
the first image and the second image each include an arrow and a background image, and
the display control unit changes the background image with time.

16. A display control device comprising a display control unit that controls display of a first image on a front surface of the vehicle, the first image indicating a traveling direction of a vehicle, and controls display of a second image on a rear surface of the vehicle, the second image indicating the traveling direction of the vehicle and different from the first image, on a basis of a state of the vehicle or position information of the vehicle.

17. A display control method of a display control device including a display control unit, the display control method comprising causing the display control unit to control display of a first image on a front surface of the vehicle, the first image indicating a traveling direction of a vehicle, and controls display of a second image on a rear surface of the vehicle, the second image indicating the traveling direction of the vehicle and different from the first image, on a basis of a state of the vehicle or position information of the vehicle.
